(19) United States
(12) Patent Application Publication
(10) Pub. No.: US 2014/0138371 A1
(43) Pub. Date: May 22, 2014

(54) RECHARGEABLE VEHICLE LIGHTER WITH USB PORT

(71) Applicant: Victor Sardar, Edison, NJ (US)

(72) Inventor: Victor Sardar, Edison, NJ (US)

(73) Assignee: DGL Group, LTD

(21) Appl. No.: 13/678,861

(22) Filed: Nov. 16, 2012

(51) Int. Cl. H05B 3/06

(52) U.S. Cl. CPC H05B 3/06
USPC 219/209

(57) ABSTRACT

The present invention provides a lighter for use with an automobile receptacle having a main body formed with a hollow interior cavity, said body having a first end and a second end and electronic circuitry operatively associated with a rechargeable battery, wherein said circuitry and battery are contained within said hollow cavity;
wherein said lighter has a heat coil incorporated therein, said heat coil actuated by a switch on the surface of the lighter;
wherein said lighter has a USB charging port contained therein.

### BACKGROUND OF THE INVENTION

From the earliest stages of the automobile industry, automobile makers have continually worked on accessorizing their automobiles. An early accessory to the automobile was the inclusion of an electronic cigarette lighter. As early as 1924, electronic cigarette lighters were standard equipment on most commercially produced automobiles. Since the beginning of the 21^{st} century automakers have slowly phased out the accessory of a cigarette lighter. The lighter has been omitted and the electrical receptacle has remained. There have been products provided with power supply devices constructed and arranged to draw power from this automobile electrical receptacle. However, there remains a significant segment of the population that would desire the cigarette lighter no longer be present. The present invention not only provides a cigarette lighter, but also provides one in an improved and safer configuration that is constructed and arranged to be used in a standard automobile receptacle, and which also provides a USB charging port.

### SUMMARY OF THE INVENTION

In one embodiment, the present invention is a lighter for use with an automobile receptacle, said lighter comprising:
a main body formed with a hollow interior cavity, said body having a first end and a second end and electronic circuitry operatively associate with a rechargeable battery, wherein said circuitry and battery are contained within said hollow cavity;
wherein said first end is constructed and arranged to supply electricity from a conventional automobile electrical receptacle and said second end is formed with an opening. In one embodiment, the second end opening is constructed and arranged to facilitate extension and retraction of a support plate having a heat coil incorporated thereon.

In another embodiment, the opening is constructed and arranged to accommodate a USB charging port. Preferably, this is the female USB port.

In the embodiment where a USB port is present, the invention further has an access channel for a user to insert a cigarette either touching, or within 0.1-1.0 cm of an internal heating coil positioned at the end of the channel terminating in the interior cavity of the lighter.

The heat coil is constructed and arranged to propagate heat sufficient to ignite an article placed between 0.0-1.0 cm of said heat coil. The lighter heat coli produces heat sufficient to ignite a cigarette or cigar placed within 0.0-1.0 cm of said heat coil. This heat, in one embodiment, is measured at a distance from 0.0-1.0 cm outward from the surface of said coil of between 300-2200 degrees Fahrenheit. As generally understood, a measurement of 0.0 cm means there is contact between the article to be ignited and the heating coil.

The electronic circuitry in said cavity accepts electrical input from said automobile electrical receptacle and provides said electricity in a configuration to charge the battery, and provides electricity to said heat coil.

In one embodiment, the lighter has a support plate and is constructed and arranged to extend outward from said cavity and retract inward into said cavity. The support plate is constructed and arranged with a spring to urge said support plate in a retracted position. The plate is extended by slidably applying pressure in the direction of the second end such that the support plate is extended outward through the opening in the second end.

The support plate is constructed and arranged such that power to the heat coil is only provided when said support plate is in a fully extended position. That is to say, extending the support plate any distance from 0-99.9% extended will not power the heat coil. Only a full 100% extension will allow the coil to receive power.

### BRIEF DESCRIPTION OF THE SEVERAL VIEWS OF THE DRAWING

FIG. 1 is a side view of the present invention.

FIG. 2 is a right side view of the present invention.

FIG. 3 is a front view of the present invention.

FIG. 4. is a bottom view of the present invention.

FIG. 5 is a top view of the present invention.

FIG. 6 is a partial front section view along section lines B-B of FIG. 2 in an embodiment whereby the heat coil is on a support plate and extended through the second end of the device.

FIG. 6A is a partial front section view along section lines B-B of FIG. 2 in an embodiment in which the heat coil is accessed through an access channel in the body.

FIG. 6B is a partial front section view along section lines B-B of FIG. 2 in an embodiment in which the heat coil support plate is in the actuated position.

FIG. 7 is a partial section view along section line A-A of FIG. 3 in an embodiment whereby the heat coil is on a support plate and extended through the second end of the device.

FIG. 7A is a partial section view along section line A-A of FIG. 3 in an embodiment in which the heat coil is accessed through an access channel in the body.

FIG. 7B is a partial section view along section line A-A of FIG. 3 in an embodiment in which the heat coil spring is compressed and support plate is in the actuated position.

FIG. 8 is a power schematic demonstrating the electric circuit of the present invention.

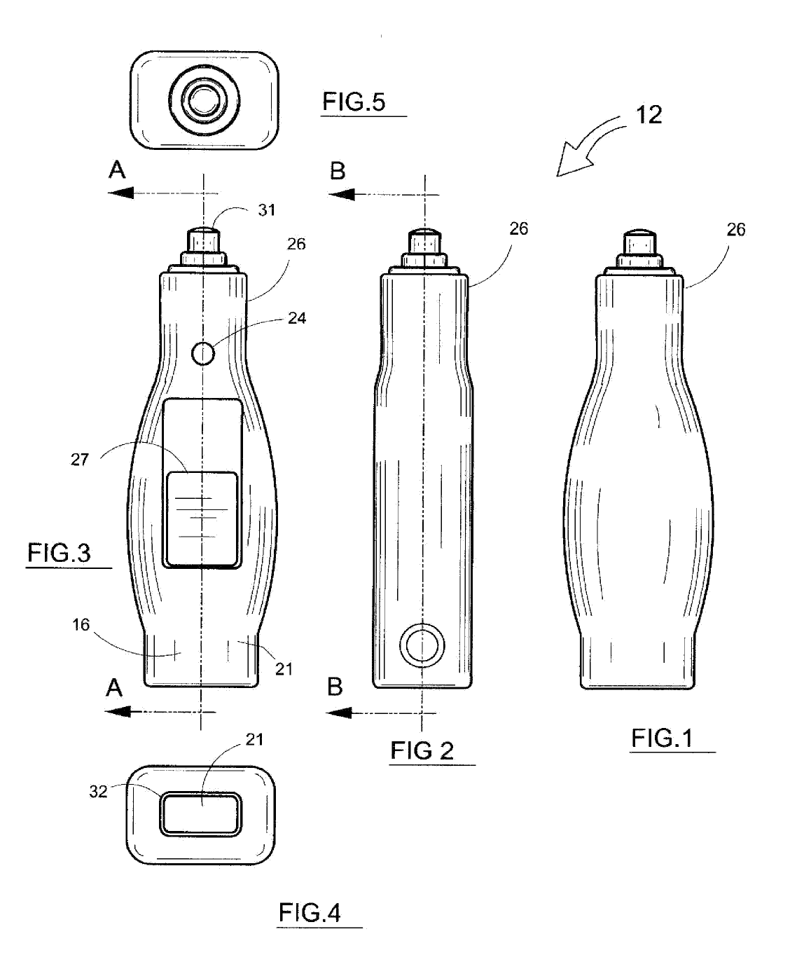

### DETAILED DESCRIPTION OF THE PREFERRED EMBODIMENT

The present invention is addressing a current need in the automobile industry. For many years, going back as far as 1924 automobiles have been provided with cigarette lighters. Recent models have ceased to provide cigarette lighters on new automobiles. Although auto makers have determined that the demand for cigarette lighters has decreased, there still exists a significant segment of the automobile buying population that desire this feature in their automobiles. The present invention addresses this need by providing a safer, newly-configured cigarette lighter to be used in an automobile receptacle and which contains a USB charging port.

Most automobiles are provided with an electrical outlet configured as a receptacle with an inside diameter: 20.93-21.01 mm (median 20.97 mm.

The receptacle is configured to receive a plug having a body diameter: 20.73-20.88 mm (median 20.805 mm).

Although the automotive electrical system is rated 12V, the actual voltage is approximately 12.5 volts when the engine is not running, approximately 14.5 volts when the engine and the alternator/generator are operating properly, and may briefly drop as low as 5-6 V during engine start. DC/DC converters will usually compensate for voltage fluctuations. In a preferred embodiment, the present invention is constructed with a DC/DC convertor and suitable circuitry to handle voltage fluctuations.

As is known in the art, equipment intended to be powered by the automobile receptacle needs to account for intermittent contact, and voltages outside the nominal 12 V DC like top voltage 9-16 V continuously, top voltage at 20 V during 1 hour, 24 V during 1 minute, 40 V during 400 ms. Protection component tolerance example ratings are +50 to −60 V DC. The present invention will be constructed to these known standards.

The present invention as demonstrated in the attached figures, provides a cigarette lighter 30 that is configured in a size and shape common to most users of automobile electronics. The size and shape of the body is substantially the same as current receptacle plug plug-in devices that are used to power devices in an automobile receptacle.

Lighter 30 is formed of a main body 26. Main body 26 has incorporated thereon an LED 24 indicating where there is power to the unit. LED 24 is constructed and arrange to both provide an indicator as to when power is being supplied to the unit and while unplugged will provide an indication to a user that there is power being supplied to heat coil 16.

The surface of body 26 has a heat switch slide body 21 that has incorporated thereon a circuit board 23 and is operatively associated with a rechargeable battery 22.

When lighter 30 is plugged into an automobile receptacle rechargeable battery 22 receives and stores electrical power until rechargeable batter 22 is fully charged. When rechargeable battery 22 is fully charged circuit board 23 will cease to provide electrical power to rechargeable battery 22.

Lighter 30 is accessed by a user moving sliding switch 27 which is housed on the surface of body 26 inside sliding switch aperture 15. In an off position sliding switch 27 contacts the off position of connector plate 19. In use when sliding switch 27 is moved in the direction opposite of the insertion end of lighter 30 sliding switch 27 contacts heat position of connector plate and simultaneously extends heat coil 16 outward from body 26. The simultaneous extends of heat coil 16 and contacting of heat position of connector plate 20 actuates electrical power to heat coil 16 such that heat coil 16 increases in surface temperature sufficiently to light a cigarette or cigar. When sliding switch 27 is returned to the closed position heat coil 16 retracts into body 26. Incorporated within body 26 and operatively associated with sliding switch 27 is switch spring return 28. In a preferred embodiment, slider switch 27 is extended by applying pressure such that heat coil 16 is extended from body 26. When pressure is released spring 28 urges slider switch 27 in a direction such that heat coil 16 is retracted and subsequently the off position of connector plate is contacted. This spring system is constructed and arranged such that heat coil 16 is only extended and actuated when handled. When no longer handled, switch spring 28 urges retraction and disconnects power to heat coil 16.

Lighter 30 has a characteristic first end well known in the art that inserts into an automobile electrical receptacle and has a contact 31 incorporated thereon. When inserted into the receptacle, the lighter 30 receives electrical power and sends the power to the interior circuitry of lighter 30. Circuit board 22 is constructed and arranged to control operation of lighter 30. Control includes providing electricity to battery 23 and appropriate transmission of information such that circuit board 22 determines the energy storage capacity of battery 23 and further interrupts electrical supply to battery 23 when storage capacity has been reached. Circuit board 22 further is operatively associated with thermal switch 35 which when said switch connector plate 17 is in the heat position of connector plate, electrical power is provided to coil 16. Circuit board 22 further is configured to effectively control and compensate for the electrical power flow through the automobile receptacle as previously described.

The second end, as best seen in FIG. 4, has a cavity border 32 through which plate 21 is extended outward from body 26 in order to access heat coil 16 and is retracted back into body 26 after use.

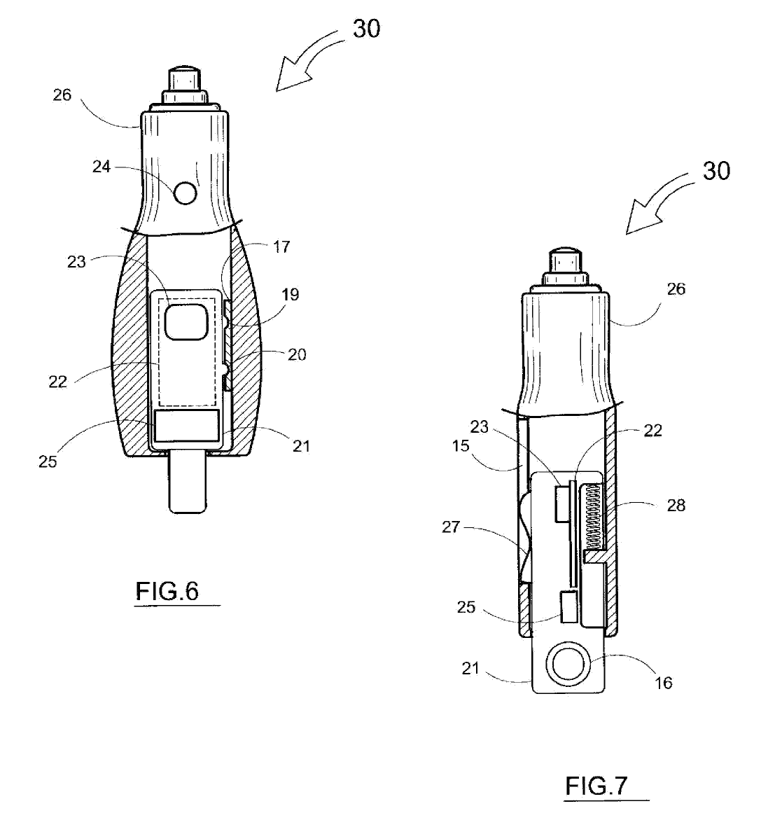

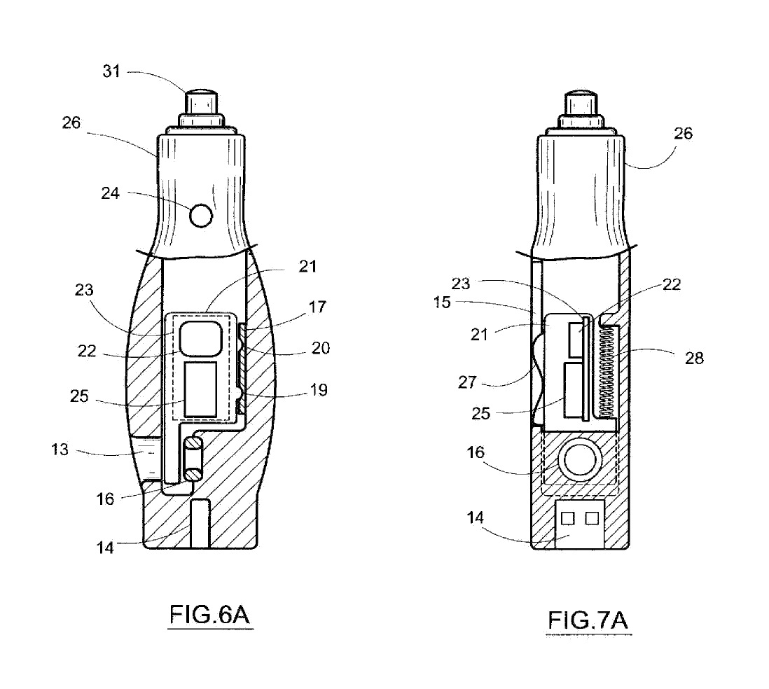

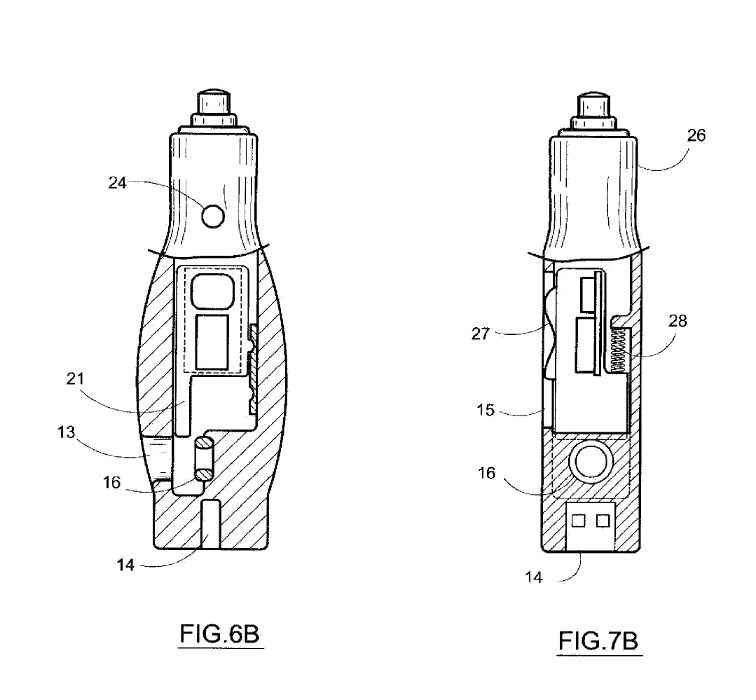

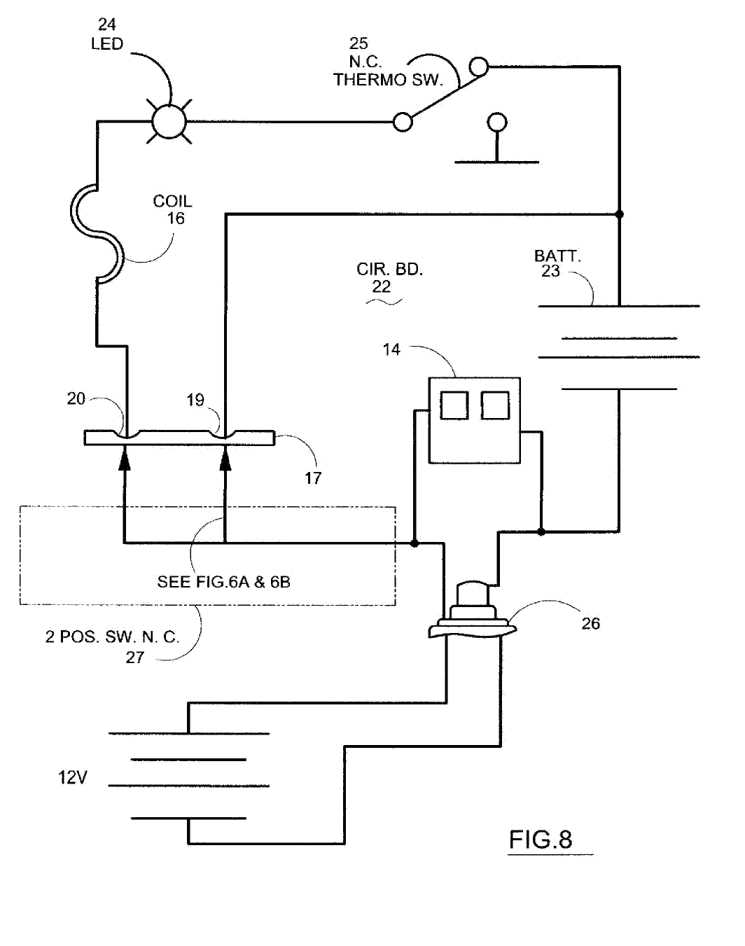

In another embodiment, as shown in FIGS. 6A, 6B and 7A, 7B, body 26 has incorporated therein, access channel 13 that is accessed through the outer surface of body 26. In one configuration, access channel 13 is an open and freely accessible orifice that provides access to heat coil 16 when the unit is actuated. Alternatively, access port 13 is covered with a suitable cover as desired. Suitable covers include, but are not limited to, slidable or pivotable door-like structures whereby a user moves the cover into a position providing access, and subsequently replaces the cover once the lighting activity is completed. In one embodiment, as seen in FIGS. 6A and 6B, plate 21 is configured with a panhandle that obstructs access to coil 16 through channel 13 when the device is not used as in FIG. 6a, and this structure moves to provide access as in FIG. 6B.

The configuration whereby access channel 13 is utilized provides an advantage in that when a user is lighting a cigarette, the ignitable distal end is places in a channel that inhibits environmental airflow from interfering with the ignition process.

In this configuration, the actuation will be the same as described above wherein sliding switch 27 which is housed on the surface of body 26 inside sliding switch aperture 15. In an off position sliding switch 27 contacts the off position of connector plate 19. In use when sliding switch 27 is moved in the direction opposite of the insertion end of lighter 30 sliding switch 27 contacts heat position of connector plate and actuates heat coil 16. The contacting of heat position of connector plate 20 actuates electrical power to heat coil 16 such that heat coil 16 increases in surface temperature sufficiently to light a cigarette or cigar. Heat coil 16 is then accessed through channel 13. When sliding switch 27 is returned to the closed position power to heat coil 16 ceases. Incorporated within body 26 and operatively associated with sliding switch 27 is switch spring return 28. In a preferred embodiment, slider switch 27 is extended by applying pressure. When pressure is released, spring 28 urges slider switch 27 in a direction such that the circuit is interrupts and power to heat coil 16 is stopped. This spring system is constructed and arranged such that power to heat coil 16 is only actuated when handled. When no longer handled, switch spring 28 urges retraction and disconnects power to heat coil 16.

In the embodiment utilizing access of coil 16 through channel 13, a USB charging port 14 is also present and allows a user to charge or power another device through a standard USB charging port.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A lighter for use with an automobile receptacle, said lighter comprising:
a main body formed with a hollow interior cavity, said body having a first end and a second end and electronic circuitry operatively associated with a rechargeable battery, wherein said circuitry and battery are contained within said hollow cavity;
wherein said first end is constructed and arranged to supply electricity from a conventional automobile electrical receptacle and said second end is formed with an opening constructed and arranged to facilitate extension and retraction of a support plate having a heat coil incorporated thereon.

2. The lighter of claim 1 wherein said heat coil is constructed and arranged to propagate heat sufficient to ignite an article placed between 0.0-1.0 cm of said heat coil.

3. The lighter of claim 1 wherein said electronic circuitry in said cavity accepts electrical input from said electrical receptacle and provides said electricity in a configuration to charge said rechargeable battery, and provides electricity to said heat coil.

4. The lighter of claim 1 wherein said heat coil produces heat sufficient to ignite a cigarette or cigar placed within 0.0-1.0 cm of said heat coil.

5. The lighter of claim 1 wherein said heat coil produces heat measured at a distance from 0.0-1.0 cm from the surface of said coil of between 300-2200 degrees Fahrenheit.

6. The lighter of claim 1 wherein said support plate is constructed and arranged to extend outward from said cavity and retract inward into said cavity.

7. The lighter of claim 1 wherein said support plate is constructed and arranged with a spring to urge said support plate in a retracted position.

8. The lighter of claim 1 wherein said support plate is constructed and arranged such that power to said heat coil is only provided when said support plate is in a fully extended position.

9. A lighter for use with an automobile receptacle, said lighter comprising:
a main body formed with a hollow interior cavity, said body having a first end and a second end and electronic circuitry operatively associate with a rechargeable battery, wherein said circuitry and battery are contained within said hollow cavity;
wherein said first end is constructed and arranged to supply electricity from a conventional automobile electrical receptacle and said body is formed with an access channel constructed and arranged to facilitate access to a heat coil incorporated therein.

10. The lighter of claim 9 wherein said heat coil is constructed and arranged to propagate heat sufficient to ignite an article placed between 0.0-1.0 cm of said heat coil.

11. The lighter of claim 9 wherein said electronic circuitry in said cavity accepts electrical input from said electrical receptacle and provides said electricity in a configuration to charge said rechargeable battery, and provides electricity to said heat coil.

12. The lighter of claim 9 wherein said heat coli produces heat sufficient to ignite a cigarette or cigar placed within 0.0-1.0 cm of said heat coil.

13. The lighter of claim 9 wherein said heat coil produces heat measured at a distance from 0.0-1.0 cm from the surface of said coil of between 300-2200 degrees Fahrenheit.

14. The lighter of claim 9 further comprising a cover on the surface of said body, wherein said cover restricts access to said channel.

15. The lighter of claim 9 further comprising a cover on the surface of said body, wherein said cover restricts access to said channel, said cover constructed and arranges to be slidably or pivotably moved to allow access to said channel and be subsequently replaced to restrict access to said channel.

16. The lighter of claim 9 further comprising a USB charging port wherein electricity is provided in said USB charging port in a configuration to charge another device.

16. The lighter of claim 15 wherein said USB charging port is a female USB charging port.
